(19) United States
(12) Patent Application Publication
(10) Pub. No.: US 2026/0136232 A1
(43) Pub. Date: May 14, 2026

(54) METHOD OF SYNCHRONIZATION OF MULTI-MODAL TRAFFIC FLOWS AND RELATED DEVICES

(71) Applicant: SHENZHEN TCL NEW TECHNOLOGY CO., LTD., Shenzhen, Guangdong (CN)

(72) Inventor: Liping WANG, Shenzhen, Guangdong (CN)

(73) Assignee: SHENZHEN TCL NEW TECHNOLOGY CO., LTD., Shenzhen, Guangdong (CN)

(21) Appl. No.: 19/121,775

(22) PCT Filed: Nov. 4, 2022
(86) PCT No.: PCT/CN2022/129928

§ 371 Date: Apr. 16, 2025

(51) Int. Cl. H04W 28/02; H04W 48/16

(52) U.S. Cl. CPC H04W 28/0236; H04W 48/16

(57) ABSTRACT

A method of synchronization of multi-modal traffic flows is provided. The method includes receiving by a network node, multi-modal traffic flows from a core network; and receiving, by the network node, Radio Access Network (RAN) delay difference threshold of multi-modal traffic flows. The network node may monitor real-time RAN delay difference of the multi-modal traffic flows, and trigger the real-time RAN delay difference reporting when it is above the RAN delay difference threshold.

### TECHNICAL FIELD

The present disclosure relates to the field of wireless communications, and more particularly, to a method of synchronization of multi-modal traffic flows and related devices BACKGROUND ART

The 5G wireless communication system has been designed to deliver Enhanced Mobile Broadband (eMBB) service for high data rate transmission, Ultra-Reliable Low Latency Communication (URLLC) service for devices requiring low latency and high link reliability and Massive Machine-Type Communication (mMTC) service to support a large number of low-power devices for a long life-time requiring highly energy efficient communication. For 5G or New Radio (NR), support of eMBB, URLLC and mMTC was introduced in Release 15 and enhanced in Rel 16 and 17. The extended Reality (XR) is a umbrella term covering Augmented Reality (AR), Mixed Reality (MR) and Virtual Reality (VR). XR applications typically require high throughput and low latency and Cloud Gaming is another application with the same requirement. XR and Cloud Gaming are important applications that will be enabled by 5G. XR service is characterized by its special traffic streams which is real-time, high data rate, low latency and multi-modal traffic at the same time.

According to 3GPP specification, tactile and multi-modal communication service of XR applications are supported in 5G system. The tactile and multi-modal communication service can be applied in multiple fields, e.g., industry, robotics and telepresence, virtual reality, augmented reality, healthcare, road traffic, serious gaming, education, culture and smart grid. These services support applications enabling input from more than one sources and/or output to more than one destinations to convey information more effectively. The input and output can be different modalities including
Video/Audio media;
Information received by sensors about the environment, e.g., brightness, temperature, humidity, etc.;
Haptic data: can be feelings when touching a surface (e.g., pressure, texture, vibration, temperature), or kinaesthetic senses (e.g., gravity, pull forces, sense of position awareness).

Immersive multi-modal VR application describes the case of a human interacting with virtual entities in a remote environment such that the perception of interaction with a real physical world is achieved. Users are supposed to perceive multiple senses (vision, sound, touch) for full immersion in the virtual environment. The degree of immersion achieved indicates how real the created virtual environment is. Even a tiny error in the preparation of the remote environment might be noticed, as humans are quite sensitive when using immersive multi-modal VR applications. Therefore, a high-field virtual environment (high-resolution images and 3-D stereo audio) is essential to achieve an ultimately immersive experience.

One of the major objectives of VR designers and researchers is to obtain more realistic and compelling virtual environments.

In addition, for immersive multi-modal VR applications, synchronization between different media components is critical in order to avoid having a negative impact on the user experience (i.e., viewers detecting lack of synchronization), particularly when the synchronization threshold between two or more modalities is less than the latency KPI for the application. Example synchronization thresholds are summarized in Table 1.

TABLE 1
Typical synchronization thresholds for immersive
multi-modality VR applications

| | |
|---|---|
| Media | synchronization threshold |
| components | (NOTE 1) |

| | | |
|---|---|---|
| audio-tactile | audio delay: | tactile delay: |
| | 50 ms | 25 ms |
| visual-tactile | visual delay: | tactile delay: |
| | 15 ms | 50 ms |
| audio-visual | audio delay: | visual delay: |
| | 20 ms | 20 ms |

(NOTE 1)
for each media component, “delay” refers to the case where that media component is delayed compared to the other.

As illustrated in Table 1, for multi-modal audio-tactile synchronization threshold, the perceptual (tactile) threshold values were 50 ms for the audio lag and the 25 ms for audio lead. As to the visual-tactile synchronization threshold, none of the participants could reliably detect the asynchrony if haptic feedback was presented less than 50 ms after the view of the contact with an object (tactile delay). The asynchrony tolerated for haptic before visual feedback was instead only 15 ms (visual delay).

According to 3GPP specification, for the use case of immersive multi-modal Virtual Reality (VR) application, the devices for immersive multi-modal VR application may include multiple types of devices such as VR glass type device, the gloves and other potential devices that support haptic and/or kinaesthetic modal. These devices which are 5G UEs are connected to the immersive multi-modal VR application server via the 5G network without any UE relays.

The interaction between immersive multi-modal VR application with multiple 5G UEs and application server via 5G network are as following:
1. The application user utilizes the devices to experience immersive multi-modal VR application. The user powers on the devices to connect to the application server, then the user starts the gaming application.
2. During the gaming running period, the devices periodically send the sensing information to the application server, including: haptic and/or kinesthetic feedback signal information which is generated by haptic device, and the sensing information such as positioning and view information which is generated by the VR glasses.
3. According to the uplink data from the devices, the application server performs necessary process operations on immersive game reality including rendering and coding the video, the audio and haptic model data, then application server periodically sends the downlink data to the devices, with different time periods respectively, via 5G network.
4. The devices, respectively, receive the data from the application server and present the related sensing including video, audio and haptic to the user.

Media synchronization requires that data from two or more modalities is synchronized to a common timeline when presented to the end user or received at the client application. Two related key issues were discussed in the recent 3GPP SA2 meetings, and many SA2 associated 5GC enhancement solutions were proposed. The two key issues and related solutions are illustrated as follows:
Key Issue #1: Policy control enhancements to support multi-modality flows coordinated transmission for single UE

This key issue studies how to support coordinated transmission for multi-modality flows with a single UE The objective of this Key Issue is to study how to enhance 5GS to better support the coordinated delivery of application traffic′ streams that are related to each other and belong to a single UE.

For key issue 1, it is assumed the application servers for tactile and multi-modal data should be deployed in one Data Network Name (DNN), and these services should belong to one Single Network Slice Selection Assistance Information (S-NSSAI). So in general, the UE may establish one Packet Data Unit (PDU) session to transmit these tactile and multi-modal flows. This solution assumes that the application server in N6 side can send out the multi-modality user plane traffic at the same time, so if we can keep the delay difference value lower, the user can get the user plane traffic at the same time.

Solution 1 is that Application Function (AF) in 5GC requests Policy Control Function (PCF) to generate delay difference threshold (as a Quality of Service (QOS) parameter) for specific couple of flows. And also, the PCF is triggered to monitor the real delay of each flow and calculate the delay difference. Based on the calculated delay difference, the PCF is able to trigger the Policy and Charging Control (PCC) rule (QOS profiles) adjustment for the couple of flows. If the AF requires that the 5GS should keep the calculated delay difference less than AF required delay difference threshold, the PCF may adjust the PCC rules for one or each of the couple of flows e g . . . using alternative QoS profile, or adjust QoS parameters e.g., using a standardized 5G QoS Identifier (SQ1) with minimize the delay difference value. For example, for the flow with a larger delay, the PCF may use alternative QoS profile with a lower end-to-end (E2E) Packet Delay Budget (PDB) or High Priority Level: for the flow with a small delay, the PCF may use alternative QoS profile with a larger E2E PDB or Low Priority Level.
Key Issue #2: Support the Application Synchronization and QoS Policy Coordination for Multi-modal Traffic among Multiple UEs

This key issue will study how to enable application synchronization and QoS policy coordination for Multi-modal Data flows (e.g., audio, video and haptic data) among multiple UEs.

Solution2 is to adopt Group policy for Multi-modal Traffic among Multiple UEs. In this mechanism, it is assumed that the group policy is already available to the related PCEs, with providing policy requirements that apply to multiple UEs and hence to multiple PCFs. When the AF session for a UE decides to update its policy, it provides the new policy requirement to the PCF serving the UE AF session, and the PCF may determine a new policy for the UE based on the updated policy requirement. When PCF receives policy requirements of multiple UEs from multiple sources, e.g., AF and other PCFs, at the same time or within a short time period, the PCF determines a group policy fulfilling all the requirements. A group policy is predefined at application level for the group of UEs. Each Policy is associated with a priority. Group policy is provisioned to the PCFs serving the group of UE(s) of XRM service.

Solution3 is to adopt same PCF selection for Multiple UEs with XRM services. In this mechanism, a UE group is identified by Internal Group Identifier. The proposed solution highlights the same PCF is selected for the PDU session related to XRM services of the group of UEs. To enable same PCF selected for the group of UEs for policy coordination for a specific service application, Internal Group Identifier is considered in addition to other factors in the PCF selection mechanism. The group of UEs subscribed to a service requiring group policy coordination, which is indicated in the Unified Data Repository (UDR) as the policy data, including Internal Group ID and Priority Level:
Internal Group ID, indicates the internal group ID of the UE.
Priority Level, indicates the priority level of the UE in the group. Indication on when there are conflicts among the policy requirements received for different UEs in the group.

Solution4 is to apply QoS policy coordination for multiple UEs' QoS flows. In this mechanism, different UEs are served by the different PCFs individually. Each PCF generates the QoS policy to each multi-modal data flow for different UEs. This solution addresses scenarios that how multiple PCFs support to coordinate the QoS policy of multiple UEs' flows (e.g., haptic, audio, and video) of a multi-modal communication session. The architecture is shown in FIG. 1.

In this solution, AF and PCF use the same Binding Support Function (BSF) for multi-modal QoS flow. BSF binds the multi-modal sessions information into the multi-modal group. And the following definition will be used in the procedures:
Multi-modal data flows group: it contains the multi-modal data flows of an application targeting to different UEs.

According to the uploaded information from different PCF (PCF 1 or PCF 2) of the multi-modal information, the BSF can establish a multi-modal profile (see Table 2) for each multi-modal data flows group. In the multi-modal profile, all of the multi-modal data flows which belong to the same multi-modal data flows group related information can be discovered.

TABLE 2
Multi-modal profile of a multi-modal data flows group

| Multiple modal profile | |
|---|---|
| Multi-modal data flows group ID = XXX | |
| Multi-modal service provider ID = ABC | |
| UE 1 related: | UE 2 related: |
| PCF IP address; PCF ID | PCF IP address; PCF ID |
| UE IP address; UE ID | UE IP address; UE ID |

What's more, according to 3GPP RAN119-e-bis meeting, the following agreements are reached:

```
  1: introduce new BS table(s) to reduce the quantisation errors (e.g., for high bit rates). FFS
how new BSR tables are created and how they impact BSR formats (can be discussed in WI
phase).
  Delay information consists of at least “remaining time”.
  2: RAN2 considers a delay information is useful for XR. FFS if dynamic reporting from
UE to network (e.g., via BSR) is needed, or whether PSDB is sufficient. If we have delay
information, it needs to distinguish how much data is buffered for which delay value. Stage-3
details (e.g., what's contained, how the triggering is done) can be discussed in the WI phase.
  If we have delay information reporting, RAN2 aims to define how the UE determines the
“remaining time” in the delay information
```

Thus, the delay information (including synchronization delay and transmission delay) needs to be discussed in RAN.

Based on the multi-model synchronization key issues and solutions discussed in SA2 meetings, the associated RAN influences or enhancements may need to be considered to fulfil the end-to-end multi-model synchronization requirement.
(1) For multi-modal with single UE scenario, how to deal with the delay difference threshold in Radio Access Network (RAN)? The synchronization delay threshold may be transmitted to RAN, thus the NG user plane interface (NG-U)/NG control plane interface (NG-C) enhancements may be needed, or uplink (UL) enhancement for UE may be needed.
(2) For multi-modal with multi UE scenario, how to deal with the multi-modal data flow group in RAN to resolve the multi-modal synchronization problem? The traffic of multi-modal data flow group may be scheduled in a uniformed way, associated scheduling enhancement may be needed.

### SUMMARY

The objective of the present application is to provide a method of synchronization of multi-modal traffic flows and related devices for solving issues in the prior arts, synchronizing multi-modal traffic, improving XR service experience, providing high resource efficiency, or providing good communication performance.

In a first aspect, an embodiment of the present application provides a method of synchronization of multi-modal traffic flows, including: receiving, by a network node, multi-modal traffic flows from a core network; and receiving, by the network node, Radio Access Network (RAN) delay difference threshold info for keeping real delay difference of the multi-modal traffic flows less than a required RAN delay difference threshold.

In a second aspect, an embodiment of the present application provides a method of synchronization of multi-modal traffic flows, including: reporting, by the UE, delay and associated buffer information of the multi-modal traffic flows to the base station via UE Assistant Information (UAI).

In a third aspect, an embodiment of the present application provides a method of synchronization of multi-modal traffic flows, including: receiving, by the base station, delay and associated buffer information of the multi-modal traffic flows reported by the UE via UE Assistant Information (UAI).

In a fourth aspect, an embodiment of the present application provides a UE, including a memory, a transceiver and a processor coupled to the memory and the transceiver, the processor configured to call and run program instructions stored in a memory, to execute the method of the first aspect.

In a fifth aspect, an embodiment of the present application provides a BS, including a memory, a transceiver and a processor coupled to the memory and the transceiver, the processor configured to call and run program instructions stored in a memory, to execute the method of the first aspect.

In a sixth aspect, an embodiment of the present application provides a UE, including a memory, a transceiver and a processor coupled to the memory and the transceiver, the processor configured to call and run program instructions stored in a memory, to execute the method of the second aspect.

In a seventh aspect, an embodiment of the present application provides a BS, including a memory, a transceiver and a processor coupled to the memory and the transceiver, the processor configured to call and run program instructions stored in a memory, to execute the method of the third aspect.

In an eighth aspect, an embodiment of the present application provides a non-transitory machine-readable storage medium having stored thereon instructions that, when executed by a computer, cause the computer to perform the method of any of the first to the third aspects.

In a ninth aspect, an embodiment of the present application provides a chip, including: a processor, configured to call and run a computer program stored in a memory, to cause a device in which the chip is installed to execute the method of any of the first to the third aspects.

In a tenth aspect, an embodiment of the present application provides a computer readable storage medium provided for storing a computer program, which enables a computer to execute the method of any of the first to the third aspects.

In an eleventh aspect, an embodiment of the present application provides a computer program product, which includes computer program instructions enabling a computer to execute the method of any of the first to the third aspects.

In a twelfth aspect, an embodiment of the present application provides a computer program, when running on a computer, enabling the computer to execute the method of any of the first to the third aspects.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating definition of multi-modal session/traffic/flow and multi-modal data flow group.

FIG. 2 is a block diagram of a user equipment and a base station of wireless communication in a communication controlling system according to an embodiment of the present disclosure.

FIG. 3 is a schematic diagram illustrating radio protocol architecture within gNB and UE.

FIG. 4 is a schematic diagram illustrating a gNB further including a centralized unit (CU) and a plurality of distributed unit (DUs).

FIG. 5 is a flowchart of a method of synchronization of multi-modal traffic flows according to a first embodiment of the present disclosure.

FIG. 6 is a schematic diagram illustrating transmission architecture for multi-model traffic with Single UE according to an embodiment of the present disclosure.

FIG. 7 is a schematic diagram illustrating RAN delay difference threshold info provided to gNB according to an embodiment of the present disclosure.

FIG. 8 is a schematic diagram illustrating gNB receiving the RAN delay difference threshold info from 5GC according to an embodiment of the present disclosure.

FIG. 9 is a schematic diagram illustrating gNB receiving the RAN delay difference threshold info from UE according to an embodiment of the present disclosure.

FIG. 10 is a schematic diagram illustrating transmission architecture for multi-model traffic with multiple UEs according to an embodiment of the present disclosure.

FIG. 11 is a flowchart of a method of synchronization of multi-modal traffic flows according to a second embodiment of the present disclosure.

FIG. 12 is a schematic diagram illustrating transmission time of UL DATA of single UE.

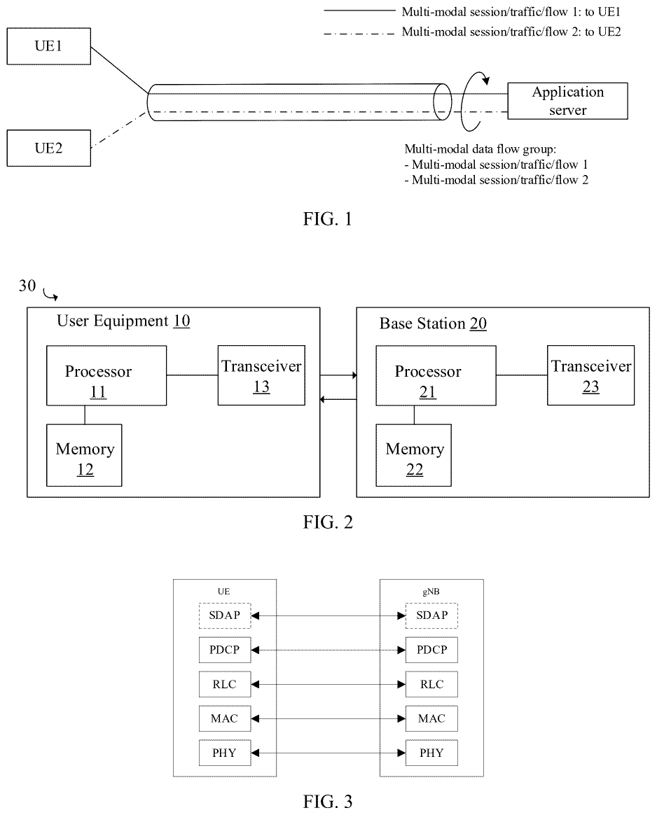

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

FIG. 2 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

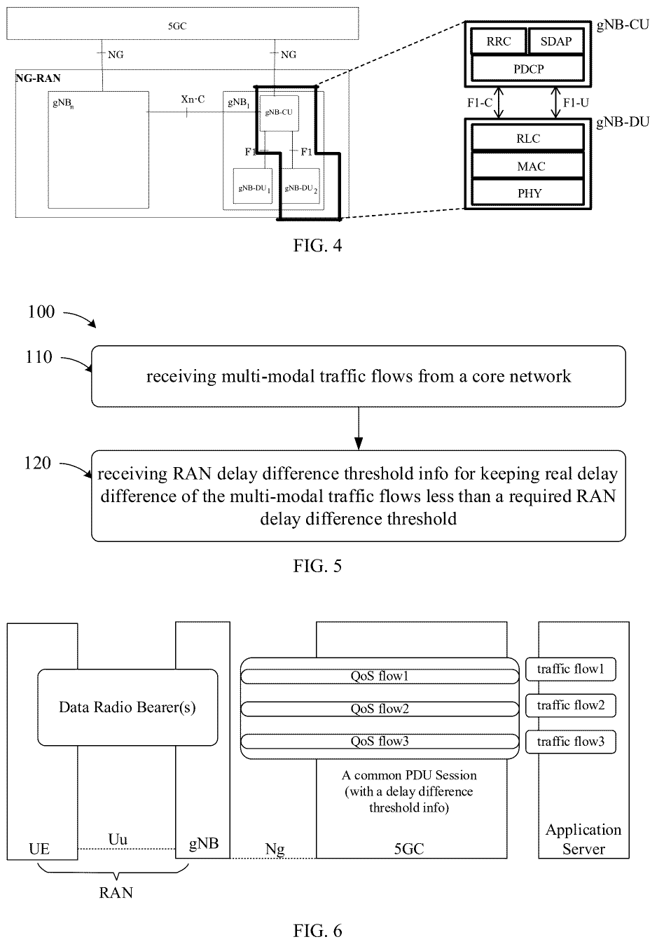

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art. The user plane radio protocol architecture within the gNB and UB is shown in FIG. 3, which includes optional Service Data Adaptation Protocol (SDAP), Packet Data Convergence Protocol (PDCP), Radio Link Control (RLC), Medium Access Control (MAC). In RAN functional split, a gNB further includes a centralized unit (CU) and a plurality of distributed unit (DUs) as shown in FIG. 4. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer and the RLC layer.

FIG. 5 is a flowchart of a method of synchronization of multi-modal traffic flows according to a first embodiment of the present disclosure. The method of method of synchronization of multi-modal traffic flows are performed at a network node. The network node can be a base station (BS) such as gNB in 5G NR or a user equipment (UE) implemented with e.g., NR communication protocol. Referring to FIG. 5 in conjunction with FIG. 2, the method 100 includes the following steps. In Step 110, the network node receives multi-modal traffic flows (with different types of media content such as video data, audio data, and sensing data, etc.) from a core network (e.g., 5GC). In an illustrated example, the multi-modal traffic flows are downlink (DL) traffic flows. In Step 120, the network node receives Radio Access Network (RAN) delay difference threshold info. The RAN delay difference threshold info contains a RAN delay difference threshold. This info is used for the network node to keep real delay difference of the multi-modal traffic flows less than a required RAN delay difference threshold. In an embodiment, the RAN delay difference threshold info may be used by gNB and received by gNB from 5GC on Ng interface, for example, via control plan message (Next Generation Application Protocol (NGAP) message) or user plan way (e.g., including the RAN delay difference threshold in the GPRS Tunnelling Protocol User Plane (GTP-U) header of DL data packet). In another embodiment, the RAN delay difference threshold info may be used by UE and received by UE from 5GC on NI interface. In still another embodiment, the RAN delay difference threshold info may be transmitted from UE to @NB on Uu interface via UE Assistant Information (UAI) and is utilized by gNB. The UAI may include Buffer status report (BSR), or UL Radio resource control (RRC) signaling, or an UL message, or an UL Packet Data Unit (PDU). The RAN delay difference threshold info may include at least one of the followings: delay difference traffic flow identifier (ID): delay difference threshold: delay difference statistics granularity; or delay difference statistics time. The network node may trigger real RAN delay difference feedback if the real delay difference of the multi-modal traffic flows is larger than or equal to the required RAN delay difference threshold. Based on the real RAN delay difference feedback, 5GC may adjust QoS profile (e.g., the end-to-end (E2E) Packet Delay Budget (PDB) or Priority Level) for the multi-modal traffic flows to realize synchronization of the multi-modal traffic flows. With this method, synchronization of multi-modal traffic is achieved, and experience on multi-modal application such as XR service is improved.

In an embodiment, the multi-modal traffic flows are transmitted to single UE. In this scenario, one common Packet Data Unit (PDU) session is established to transmit the multi-modal traffic flows, and the common PDU session is characterized with the RAN delay difference threshold. The multi-modal traffic flows transmitted in the common PDU session are synchronized to a common timeline. In another embodiment, the multi-modal traffic flows are transmitted to multiple UEs. In this scenario, a separate PDU session is established for each UE, and the PDU sessions which belong to a same multi-modal data flows group is characterized with the RAN delay difference threshold. The multi-modal traffic flows of the multi-modal data flows group are synchronized to a common timeline.

In some embodiments, for either the multi-modal traffic flows transmitted for single UE or the multi-modal traffic flows transmitted for multiple UEs, one or more Data Radio Bearers (DRBs) are established (between gNB and single UE or between gNB and each of multiple UEs) to transmit multi-modal PDU sets for the multi-modal traffic flows. The gNB may monitor DRB delay for the one or more DRBs and trigger real RAN delay difference feedback according to the monitoring result. The DRB delay monitoring and the real RAN delay difference feedback triggering may also be carried out by the UE. If one DRB is set up for the multi-modal PDU sets, the network node (gNB or UE) detects single DRB transmission delay as real RAN delay. When the real RAN delay is larger than or equal to a required PDU Set delay budget (PSDB), the network node triggers real RAN delay difference feedback. If more than one DRBs are set up for the multi-modal PDU sets, the network node (gNB or UE) detects each DRB transmission delay and calculating a real RAN delay difference based on the DRB transmission delay. When the real RAN delay difference is larger than or equal to the required RAN delay difference threshold, the network node triggers real RAN delay difference feedback.

Further details on how to synchronize downlink (DL) multi-modal flows are provided below.

Multi-Model Traffic with Single UE in DL

In this scenario, the application client(s) of the different types of data is located at one UE, and multi-modality flows are coordinately transmitted with a single UE. The UE may establish one PDU session to transmit these multi-modal flows.

The transmission architecture for multi-model traffic with single UE is shown in FIG. 6. Firstly, the application server sends the multi-modal traffic flows to 5GC, 5GC establishes a common PDU session for the multi-modal traffic flows of UE. The common PDU session is characterized with delay difference threshold (a common timeline), which means all the traffic flows of the common PDU session are synchronized to a common timeline when presented to the end user. 5GC may generate delay difference threshold (as a QoS parameter) for the specific multi-modal traffic flows, and also the 5GC will monitor and calculate the real transmission delay of the specific traffic flows. Based on the monitoring result, the 5GC will adjust the QoS profile (e.g., the E2E PDB or Priority Level) for the specific traffic flows.

Then, the multi-modal traffic flows are sent with the basic XR granularity of PDU sets by 5GC to the RAN RAN may establish one or more Data Radio Bearers (DRBs) between gNB and UE to transmit the multi-modal PDU sets.

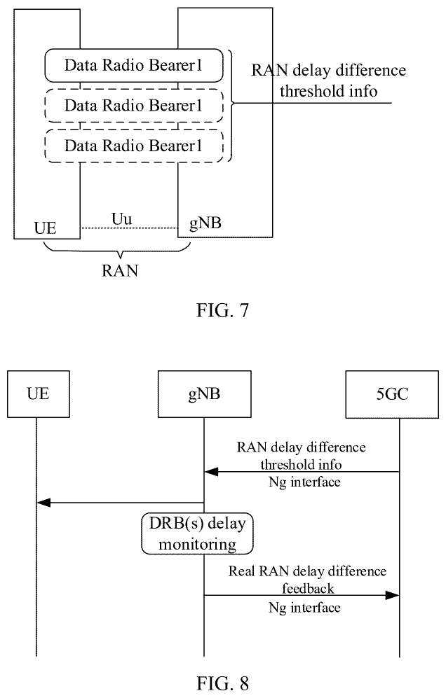

Since the delay difference threshold is an end-to-end timeline requirement, to fulfil the synchronization of multi-traffic of one UE, it is necessary for the 5GC to send RAN delay difference threshold info to gNB as shown in FIG. 7, which is used for RAN to keep the real delay difference of multi-traffic less than the required RAN delay difference threshold. As to RAN, because the multi-modal PDU sets from multi-modal traffic flows are required to have a common timeline, RAN may establish one ore more DRBs (an integrated DRB set) to handle the multi-modal PDU sets.

In this embodiment, a mechanism is introduced for introducing the RAN delay difference threshold info to gNB, and the further processing behaviour of gNB.

RAN delay difference threshold info includes at least one of the following info:
Delay difference traffic flow ID;
Delay difference threshold;
Delay difference statistics granularity (PDU Set granularity or traffic flow granularity); Delay difference statistics time;

As shown in FIG. 8, 5GC sends RAN delay difference threshold info to gNB via control plan message NGAP message) or user plan way (e.g., including the RAN delay difference threshold in the GTP-U header of DL data packet).

After the gNB received the RAN delay difference threshold info and transmitted the multi-modal traffic data on the established DRB(s), gNB starts to monitor the real RAN delay difference of the multi-modal traffic data.
1. If one DRB is set up for the multi-modal PDU sets, gNB only needs to detect the single DRB transmission delay (i.e., the real RAN delay) on Uu interface. When the real RAN delay is larger than or equal to the required PSDB, gNB may trigger the real RAN delay difference feedback via control plan message (NGAP message) or user plan way (e.g., including the real RAN delay in the GTP-U header of DL data packet) to 5GC.
2. If more than one DRBs are set up for the multi-modal PDU sets, gNB needs to detect each of the DRB's transmission delay on Uu interface and calculate the real RAN delay difference. When the real RAN delay difference is larger than or equal to the required RAN delay difference threshold, gNB may trigger the real RAN delay difference feedback via control plan message (NGAP message) or user plan way (e.g., including the real RAN delay in the GTP-U header of DL data packet) to 5GC.

Based on the real RAN delay feedback, 5GC may adjust the PCC rules for one or each of the multi-modal flows e.g., using alternative QoS profile, or adjust QoS parameters e.g., using a standardized 5QI with minimized the delay difference value. For example, for the flow with a larger delay, the PCF may use alternative QoS profile with a lower E2E PDB or High Priority Level.

Single UE with Multi-Model Traffic in DL

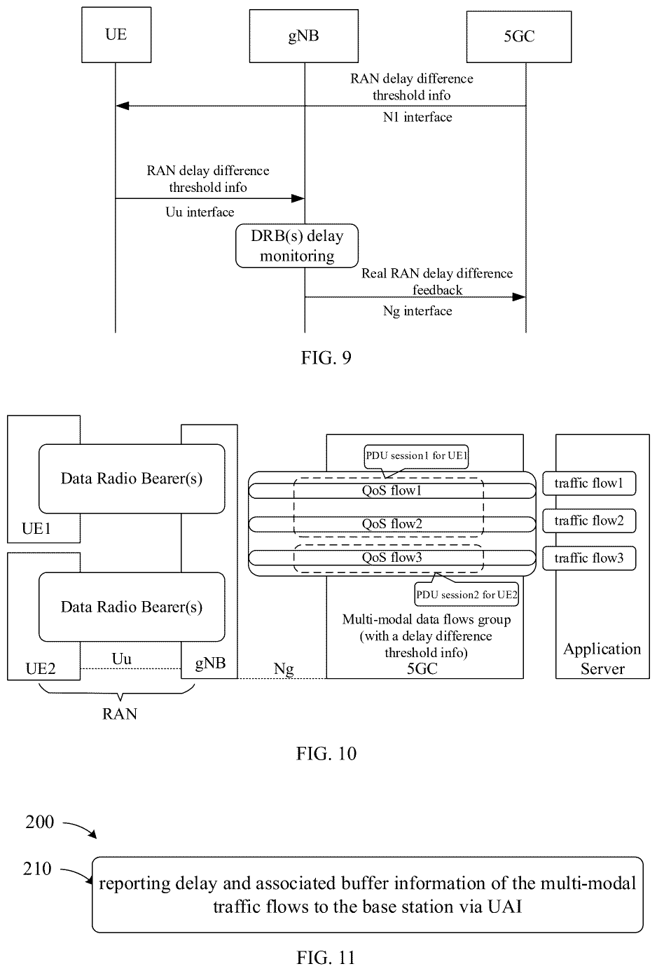

In this embodiment, a mechanism is introduced for introducing the RAN delay difference threshold info to gNB, and the further processing behaviour of gNB. As shown in FIG. 9. 5GC sends RAN delay difference threshold info to UE on NI interface by Non-Access-Stratum (NAS) signalling which is transparent to gNB.

RAN delay difference threshold info includes at least one of the following info:
Delay difference traffic flow ID;
Delay difference threshold;
Delay difference statistics granularity (PDU Set granularity or traffic flow granularity);
Delay difference statistics time:

Then UE transmits the RAN delay difference threshold info to gNB on Uu interface via UAI (UE Assistant Information), for example, the Buffer Status report (BSR) reporting or UL RRC messages.

After the gNB received the RAN delay difference threshold info and transmitted the multi-modal traffic data on the established DRB(s), gNB starts to monitor the real RAN delay difference of the multi-modal traffic data.
1. If one DRB is set up for the multi-modal PDU sets, gNB only needs to detect the single DRB transmission delay (i.e., the real RAN delay) on Uu interface. When the real RAN delay is larger than or equal to the required PSDB, gNB may trigger the real RAN delay difference feedback via control plan message (NGAP message) or user plan way (e.g., include the real RAN delay in the GTP-U header of DL data packet) to 5GC.
2. If more than one DRBs are set up for the multi-modal PDU sets, gNB needs to detect each of the DRB's transmission delay on Uu interface and calculate the real RAN delay difference. When the real RAN delay difference is larger than or equal to the required RAN delay difference threshold, gNB may trigger the real RAN delay difference feedback via control plan message (NGAP message) or user plan way (e.g., include the real RAN delay in the GTP-U header of DL data packet) to 5GC.

Alternatively, the UE is also able to monitor the real RAN delay difference of the multi-modal traffic data, and then feeds back the real RAN delay difference to 5GC. When the real RAN delay difference is larger than or equal to the required RAN delay difference threshold, UE may trigger the real RAN delay difference feedback via control plan message (NGAP message) or user plan way (e.g., including the real RAN delay in the GTP-U header of DL data packet) to 5GC.

Based on the real RAN delay feedback, 5GC may adjust the PCC rules for one or each of the multi-modal flows e.g., using alternative QoS profile, or adjust QoS parameters e.g., using a standardized SQL with minimized the delay difference value. For example, for the flow with a larger delay, the PCF may use alternative QoS profile with a lower E2E PDB or High Priority Level.

Multi-Model Traffic with Multiple UE in DL

In this scenario, the application client(s) of the different types of data is located at multiple UEs, and multi-modality flows are coordinatedly transmitted with multiple UEs. The UEs may establish separate PDU sessions to transmit those multi-modal flows. According to the afore-described Solution2 and Solution3, the group policy for Multi-modal Traffic among Multiple UEs is adopted. The afore-described Solution 4 proposes to setup a multi-modal data flows group for the multi-modal flows of multi-UEs, and a multi-modal profile was also established for each multi-modal data flows group.

The transmission architecture for multi-model traffic with multiple UEs is shown in FIG. 10. Firstly, the application server sends the multi-modal traffic flows of multiple UEs to 5GC, 5GC establishes separate PDU Session for each UE, and those PDU Sessions which belong to the same multi-modal data flows group is characterized with delay difference threshold (a common timeline), which means all the traffic flows of the multi-modal data flows group are synchronized to a common timeline when presented to the end users.

Then, the multi-modal traffic flows are sent with the basic XR granularity of PDU sets by 5GC to the RAN. RAN may establish one or more than one DRBs between gNB and each UE to transmit the multi-modal PDU sets.

Since the delay difference threshold is an end-to-end timeline requirement, to fulfil the synchronization of multi-traffic of multiple UEs, it is necessary for the 5GC to send RAN delay difference threshold to gNB, which is used for RAN to keep the real delay difference of multi-traffic less than the required RAN delay difference threshold. As to RAN, because the multi-modal PDU sets from multi-modal traffic flows are required to have a common timeline, RAN may establish one DRB or more than DRBs (an integrated DRB set) for each UE to handle the multi-modal PDU sets.

In this embodiment, a mechanism is introduced for introducing the RAN delay difference threshold to gNB, and the further processing behaviour of gNB. 5GC sends RAN delay difference threshold to gNB via control plan message (NGAP message) or user plan way (e.g., including the RAN delay difference threshold in the GTP-U header of DL data packet).

After the gNB received the RAN delay difference threshold and transmitted the multi-modal traffic data on the established DRB(s), gNB starts to monitor the real RAN delay difference of the multi-modal traffic data.

Then, gNB needs to detect each of the DRB's transmission delay on Uu interface and calculate the real RAN delay difference for each UE. When the real RAN delay difference is larger than or equal to the required RAN delay difference threshold, gNB may trigger the real RAN delay difference feedback via control plan message (NGAP message) or user plan way (e.g., including the real RAN delay in the GTP-U header of DL data packet). Based on the real RAN delay feedback, 5GC may adjust the PCC rules for one or each of the multi-modal flows e.g., using alternative QoS profile, or adjust QoS parameters e.g., using a standardized 5QI with minimized the delay difference value. For example, for the flow with a larger delay, the PCF may use alternative QoS profile with a lower E2E PDB or High Priority Level.

Alternatively, gNB may adjust the scheduling priority of different UE. For example, for the larger delay traffic flow UE, gNB may prioritize the resource allocation of UE, or adjust the scheduling priority of different traffic flows. For example, for the larger delay traffic flow, gNB may prioritize the resource allocation of traffic flow DRB.

FIG. 11 is a flowchart of a method of synchronization of multi-modal traffic flows according to a second embodiment of the present disclosure. Referring to FIG. 11 in conjunction with FIG. 2, the method 200 includes the following steps. In Step 210, a user equipment (UE) reports delay and associated buffer information of the multi-modal traffic flows to the base station via UE Assistant Information (UAI). The UAI may include Buffer status report (BSR), or UL Radio resource control (RRC) signaling, or an UL message, or an UL Packet Data Unit (PDU). In an illustrated example, the multi-modal traffic flows are uplink (UL) traffic flows. The UE transmits multi-modal traffic flows to the base station. The base station can be gNB in 5G NR, and the UE may be implemented with NR communication protocol, for example, the delay and associated buffer information of the multi-modal traffic flows is reported to the base station to assist the base station get an UL real delay difference of the multi-modal traffic flows Once the base station gets the UL real delay difference, the base station can adjust scheduling priority of different uplink multi-modal traffic flows, or adjust scheduling priority of different UEs, thereby achieving synchronization of uplink multi-modal traffic flows. One or more Data Radio Bearers (DRBs) are established between the UE and the base station to transmit multi-modal PDU sets for the multi-modal traffic flows. The delay and associated buffer information may include at least one of the followings: start sending time of PDU set; end sending time of PDU set; difference start sending delay of the synchronization PDU sets: difference end sending delay of the synchronization PDU sets; remaining buffer size of PDU set; or remaining delay for the remaining buffer size of PDU set. The reporting may be triggered when remaining delay for remaining buffer size is larger than remaining budget. Alternatively, the reporting may be triggered when the UL real delay difference is larger than a Radio Access Network (RAN) delay difference threshold. With this method, synchronization of multi-modal traffic is achieved, and experience on multi-modal application such as XR service is improved.

In an embodiment, the UL multi-modal traffic flows are transmitted for single UE. In this scenario, one common Packet Data Unit (PDU) session is established to transmit the multi-modal traffic flows, and the common PDU session is characterized with the RAN delay difference threshold. The multi-modal traffic flows transmitted in the common PDU session are synchronized to a common timeline. In another embodiment, the UL multi-modal traffic flows are transmitted for each of multiple UEs. In this scenario, a separate PDU session is established for each UE, and the PDU sessions which belong to a same multi-modal data flows group is characterized with the RAN delay difference threshold. The multi-modal traffic flows of the multi-modal data flows group are synchronized to a common timeline.

A method of synchronization of UL multi-modal traffic flows performed by the base station is also provided. Details of this method can be referred to the afore-described method performed by the UE and the following descriptions and are not elaborated for simplicity.

Further details on how to synchronize uplink (UL) multi-modal flows are provided below:

### Multi-Model Traffic for Single UE in UL

In this scenario, the application client(s) of the different types of data is located at one UE, and multi-modality flows are coordinatedly transmitted with a single UE. The UE may establish one PDU session to transmit these multi-modal flows.

For UL transmission, the UL multi-modal traffic synchronization is also necessary. The UL multi-modal traffic also needs to be characterized with delay difference threshold (a common timeline), which means all the traffic flows of the same UE is synchronized to a common timeline when presented to the end application server. Since the delay difference threshold is an end-to-end timeline requirement, to fulfil the synchronization of multi-traffic of one UE, it is necessary for the 5GC to send RAN delay difference threshold to gNB, which is used for RAN to keep the UL real delay difference of multi-traffic less than the required RAN delay difference threshold. As to RAN, because the multi-modal PDU sets from multi-modal traffic flows are required to have a common timeline, RAN may establish one DRB or more than one DRB (an integrated DRB set) with UE to handle the multi-modal PDU sets.

What's more, since the UL transmission is based on the gNB resource allocation, but gNB is unaware of the arriving time of the UL data, it is hard for gNB to judge whether the UL real delay difference of multi-traffic is satisfied with the required RAN delay difference threshold Thus, associated UL enhancement is necessary.

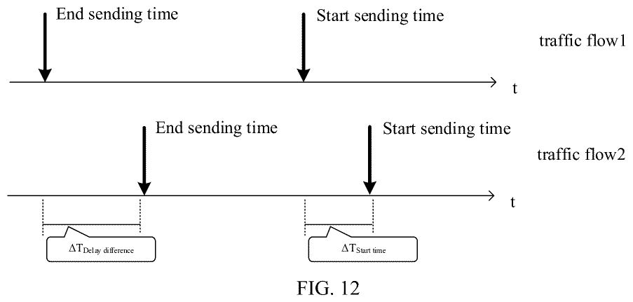

As is shown in FIG. 12, the transmission time (start sending time and end sending time) of two traffic flows of the same UE is illustrated. And the theoretical formula of delay difference is shown below, which is equal to the difference of PSDB (PDU Set delay budget) of two traffic flows plus the difference of start sending time of two traffic flows.

$$Δ {T}_{Delay difference} = Δ {T}_{PSDB} + Δ {T}_{Start time}$$

However, because of the jitter and real transmission channel situation, the real arriving time of each UL traffic flow may be different from the theoretical value (i.e., starting time+PSDB). Thus, it is necessary for the UE to report the associated delay information to gNB to assist gNB get the UL real delay difference of multi-traffic and further judge whether it is satisfied with the required RAN delay difference threshold.

In this embodiment, a mechanism is introduced for UE to report delay information to gNB One of the delay and associated buffer information may include:
Start sending time of PDU set,
End sending time of PDU set;
Difference start sending delay of the synchronization PDU sets,
Difference end sending delay of the synchronization PDU sets;
Remaining buffer size of PDU set,
Remaining delay for the remaining buffer size of PDU set;

UE may use UL RRC signalling or UL BSR, or UL SR to send the delay information to gNB. And the reporting is triggered when the remaining delay is larger than the remaining PSDB or when the UL real delay difference of multi-traffic is larger than the RAN delay difference threshold.

### Multi-Model Traffic for Multiple UEs in UL

In this scenario, the application client(s) of the different types of data is located at multiple UEs, and multi-modality flows are coordinatedly transmitted with multiple UEs. The UEs may establish separate PDU sessions to transmit those multi-modal flows.

For UL transmission, the UL multi-modal traffic synchronization is also necessary. The UL multi-modal traffic also needs to be characterized with delay difference threshold (a common timeline), which means all the traffic flows of the multiple UEs are synchronized to a common timeline when presented to the end application server. Since the delay difference threshold is an end-to-end timeline requirement, to fulfil the synchronization of multi-traffic of multiple UEs, it is necessary for the 5GC to send RAN delay difference threshold to gNB, which is used for RAN to keep the UL real delay difference of multi-traffic less than the required RAN delay difference threshold. As to RAN, because the multi-modal PDU sets from multi-modal traffic flows are required to have a common timeline, RAN may establish one DRB or more than one DRB (an integrated DRB set) with each UE to handle the multi-modal PDU sets.

What's more, since the UL transmission is based on the gNB resource allocation, but gNB is unaware of the arriving time of the UL data, it is hard for gNB to judge whether the UL real delay difference of multi-traffic is satisfied with the required RAN delay difference threshold Thus, associated UL enhancement is necessary.

As illustrated above, the theoretical formula of delay difference is shown below, which is equal to the difference of PSDB (PDU Set delay budget) of two traffic flows plus the difference of start sending time of two traffic flows.

$$Δ {T}_{Delay difference} = Δ {T}_{PSDB} + Δ {T}_{Start time}$$

However, because of the jitter and real transmission channel situation, the real arriving time of each UL traffic flow may be different from the theoretical value (i.e., starting time+PSDB). Thus, it is necessary for the multiple UEs to report the associated delay information to gNB to assist gNB get the UL real delay difference of multi-traffic of multiple UEs and further judge whether it is satisfied with the required RAN delay difference threshold.

In this embodiment, a mechanism is introduced for UE to report delay information to gNB One of the delay and associated buffer information may include:
Start sending time of PDU set,
End sending time of PDU set;
Difference start sending delay of the synchronization PDU sets;
Difference end sending delay of the synchronization PDU sets;
Remaining buffer size of PDU set;
Remaining delay for the remaining buffer size of PDU set;

UE may use UL RRC signalling or UL BSR, or UL SR to send the delay information to gNB. And the reporting is triggered when the remaining delay is larger than the remaining PSDB or when the UL real delay difference of multi-traffic is larger than the RAN delay difference threshold.

Commercial interests for some embodiments are as follows. 1. solving issues in the prior art. 2. synchronizing multi-modal traffic. 3. improving XR service experience. 4. providing high resource efficiency. 5. providing a good communication performance. Some embodiments of the present disclosure are used by SG-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present application further provides a computer readable storage medium for storing a computer program. The computer readable storage medium enables a computer to execute corresponding processes implemented by the UE/BS in each of the methods of the embodiment of the present application. For brevity, details will not be described herein again.

The embodiment of the present application further provides a computer program product including computer program instructions. The computer program product enables a computer to execute corresponding processes implemented by the UE/BS in each of the methods of the embodiment of the present application. For brevity, details will not be described herein again.

The embodiment of the present application further provides a computer program. The computer program enables a computer to execute corresponding processes implemented by the UE/BS in each of the methods of the embodiment of the present application. For brevity, details will not be described herein again.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A method of synchronization of multi-modal traffic flows, comprising:
receiving, by a network node, multi-modal traffic flows from a core network; and
receiving, by the network node, Radio Access Network (RAN) delay difference threshold info for keeping real delay difference of the multi-modal traffic flows less than a required RAN delay difference threshold.

2. The method of claim 1, further comprising:
triggering real RAN delay difference feedback if the real delay difference of the multi-modal traffic flows is larger than or equal to the required RAN delay difference threshold.

3. The method of claim 1, wherein the RAN delay difference threshold is received via control plan message.

4. The method of claim 1, wherein the RAN delay difference threshold is received via user plan way.

5. The method of claim 1, wherein the RAN delay difference threshold info comprises at least one of the followings:
delay difference traffic flow identifier (ID);
delay difference threshold;
delay difference statistics granularity; or
delay difference statistics time.

6. The method of claim 1, wherein the network node is a base station.

7. The method of claim 6, wherein the RAN delay difference threshold info is received from a UE via UE Assistant Information (UAI).

8. The method of claim 7, wherein the UAI comprises Buffer status report (BSR), or UL Radio resource control (RRC) signaling, or an UL message, or an UL Packet Data Unit (PDU).

9. The method of claim 1, wherein the network node is a UE.

10. The method of claim 9, wherein the RAN delay difference threshold info is received by the UE from the core network.

11. A method of synchronization of multi-modal traffic flows, comprising:
reporting, by the UE, delay and associated buffer information of the multi-modal traffic flows to the base station via UE Assistant Information (UAI).

12. The method of claim 11, wherein the UAI comprises Buffer status report (BSR), or UL Radio resource control (RRC) signaling, or an UL message, or an UL Packet Data Unit (PDU).

13. The method of claim 11, wherein the reporting is triggered when remaining delay for remaining buffer size is larger than remaining budget.

14. The method of claim 11, wherein the reporting is triggered when the UL real delay difference is larger than a Radio Access Network (RAN) delay difference threshold.

15. The method of claim 11, wherein the delay and associated buffer information comprises at least one of the followings:
start sending time of PDU set;
end sending time of PDU set;
difference start sending delay of the synchronization PDU sets;
difference end sending delay of the synchronization PDU sets;
remaining buffer size of PDU set; or
remaining delay for the remaining buffer size of PDU set.

16. A user equipment (UE), comprising a memory, a transceiver and a processor coupled to the memory and the transceiver, the processor configured to call and run program instructions stored in a memory, to execute operations comprising:
receiving, by a network node, multi-modal traffic flows from a core network; and
receiving, by the network node, Radio Access Network (RAN) delay difference threshold info for keeping real delay difference of the multi-modal traffic flows less than a required RAN delay difference threshold.

17-20. (canceled)
